(19) United States
(12) Patent Application Publication
(10) Pub. No.: US 2025/0101689 A1
(43) Pub. Date: Mar. 27, 2025

(54) INFILL MATERIAL FOR SYNTHETIC TURF SURFACE AND RELATED PRODUCTION PROCESS

(71) Applicant: SUE - SPORTS UNIFIED EUROPE, LDA, Braga (PT)

(72) Inventors: Reed J. SEATON, AUSTIN, TX (US); Luis Filipe V. MACEDO, BRAGA (PT)

(21) Appl. No.: 18/833,702

(22) PCT Filed: Dec. 23, 2022
(86) PCT No.: PCT/IB2022/062727

§ 371 Date: Jul. 29, 2024

(30) Foreign Application Priority Data
Jan. 28, 2022 (PT) 117767
Feb. 28, 2022 (EP) 22159096.1

(51) Int. Cl. E01C 13/08; B29B 7/48; B29B 9/06; B29B 9/12; B29K 67/00; B29K 105/00; B29K 105/16; C08K 5/136; C08K 5/1515; C08K 5/54; C08K 11/00

(52) U.S. Cl. CPC E01C 13/08; B29B 7/48; B29B 9/06; B29B 9/12; C08K 5/136; C08K 5/1515; C08K 5/5406; C08K 11/005; B29K 2067/046; B29K 2105/0011; B29K 2105/0038; B29K 2105/16

(57) ABSTRACT

Infill material (200) for a synthetic turf surface (400), the infill material (200) comprising a plurality of particles (201) each one comprising: —a polymeric matrix made of a polymeric material selected in the group: polylactic acid (PLA), polybutylene adipate terephthalate (PBAT), polyglycolic acid (PGA), polycaprolactone (PCL), poly(lactic-co-glycolic) acid (PLGA), poly-(2-hydroxyethyl-methacrylate), poly-ethylene-glycol (PEG), chitosan, hyaluronic acid, a poly-hydroxy-alkanoate (PHA), or combinations thereof; —a reinforcing filler made of a plant material dispersed in the polymeric matrix.

### TECHNICAL FIELD OF THE INVENTION

The present invention relates to an infill material for a synthetic turf surface and to a production process of an infill material.

### STATE OF THE ART

In the making of surfaces for sports use (e.g., soccer fields, football fields, rugby fields, baseball fields, etc.) and/or for decorative use (e.g., gardens), a rigid and compact substrate (e.g., in clay or asphalt) is typically prepared and then a synthetic turf mat comprising artificial fibres simulating the natural grass is laid above the substrate. In addition, a layer of material called infill (which can be made of various materials such as rubber granules, even recycled rubber granules; sand; plant material, such as cork and/or coconut; etc.) is typically spread on the synthetic turf mat between the artificial fibres. The infill structurally stabilizes the synthetic turf mat and/or improves its aesthetic quality, making it look more likely to the natural grass (as it facilitates the upright position of the artificial fibres), and/or improves the performance properties of the mat (for example in terms of mechanical response of the mat, rolling/bouncing of the ball, etc.) thus facilitating its use for sports.

US2010055461A1, US2018080183A1, WO2006109110A1 and US2015252537A1 disclose a respective infill material originating from plant materials.

WO2016205087A1 disclose a granular infill material comprising a thermoplastic polymeric matrix and a cellulose-based filler.

### SUMMARY OF THE INVENTION

The Applicant has realized that known infill materials have some drawbacks or can be improved in one or more aspects.

The Applicant has observed that the use of plant materials as such (possibly mixed with sand or rubber material), as disclosed in US2010055461A1, US2018080183A1, WO2006109110A1 and US2015252537A1, leads to an infill material with unsatisfactory performance properties during use of the synthetic turf mat, or an infill material which does not maintain the performance properties over time.

For example, the deformation of the infill material (e.g., due to the trampling action of the users) causes an increase in the wear of the synthetic turf mat (e.g., since the deformation involves a decrease in the volume of the infill and consequently a greater portion of the artificial fibres is left free and, thus, subjected to wear during use of the mat) and/or a loss of the ability to efficiently cushion/absorb the stresses to which the synthetic turf mat is subjected during use (causing for example a decrease in comfort for the users and/or an increase in the injury risk, e.g., joint injuries).

In addition, the water-retaining properties of the infill material are strongly dependent on the water-retaining properties of the specific plant material, in particular its hygroscopicity (i.e., the ability to absorb humidity in the air) and its hydrophilicity (i.e., the ability to absorb water in liquid form, e.g., rain or actively sprayed on the mat). On one hand, in case of low water-retaining properties of the plant material, there is a risk of excessive overheating of the synthetic turf mat (e.g., due to sun irradiation) and/or a waste of water (actively sprayed) for cooling the synthetic turf mat and/or an increase in injury risk due to the high friction given by the dry synthetic turf mat. On the other hand, in case of excessive water-retaining properties of the plant material, there is the risk of a weakening of the infill material with consequent loss of performance properties of the infill material.

Biodegradation is a process of breakdown of a material/substance performed by the action of microorganisms (such as bacteria and/or fungi). Typically, the biodegradation comprise three steps: i) biodeterioration which modifies the mechanical, physical and/or chemical properties of the material/substance and occurs when the material/substance is exposed to abiotic factors in the outdoor environment (e.g., stresses, light, high temperature and/or chemicals), ii) bio-fragmentation which is the breaking of the polymeric chains of the material/substance into oligomers (short polymeric chains having low molecular weight) and monomers, and iii) assimilation of the oligomers and/or monomers by the microorganisms.

By “not biodegradable” referred to a material/substance it is meant that the biodegradation of the material/substance occurs in a time interval in the order of several tens of years, e.g., at least about 50 or 100 years.

The Applicant has also observed that the use of thermoplastic polymeric material (e.g., PVC, PE, PET, PP), as disclosed in WO2016205087A1, can cause health risks for the users of the synthetic turf mat and/or pollution risks for the environment, e.g., since the above polymeric materials are (substantially) not biodegradable and also release toxic/reactive substances during biodegradation (e.g., oligomers/monomers which are unstable components, which could cause health risks).

The Applicant has therefore faced the problem of obtaining, through an ecologically-friendly production process, an infill material for a synthetic turf surface, which is endowed with the desired performance properties (e.g., in terms of mechanical and/or water-retaining properties), and at the same time is (relatively rapidly and/or highly) biodegradable, preferably with little or no release of toxic/reactive substances for both the users of the synthetic turf surface and the environment.

According to the Applicant, the above problem is solved by an infill material for a synthetic turf surface and a production process of an infill material according to the attached claims and/or having one or more of the following features.

According to an aspect the invention relates to an infill material for a synthetic turf surface, said infill material comprising a plurality of particles each one comprising:
a polymeric matrix made of a polymeric material selected in the group: polylactic acid (PLA), polybutylene adipate terephthalate (PBAT), polyglycolic acid (PGA), polycaprolactone (PCL), poly(lactic-co-glycolic) acid (PLGA), poly-(2-hydroxyethyl-methacrylate), poly-ethylene-glycol (PEG), chitosan, hyaluronic acid, a poly-hydroxy-alkanoate (PHA), or combinations thereof;
a reinforcing filler dispersed in said polymeric matrix, the reinforcing filler being made of a plant material.

According to an aspect the invention relates to a production process of an infill material for a synthetic turf surface, wherein the infill material comprises a plurality of particles, the process comprising:
providing fragments of a plant material;
providing a polymeric material selected in the group: polylactic acid (PLA), polybutylene adipate terephthalate (PBAT), polyglycolic acid (PGA), polycaprolactone (PCL), poly(lactic-co-glycolic) acid (PLGA), poly-(2-hydroxyethyl-methacrylate), poly-ethylene-glycol (PEG), chitosan, hyaluronic acid, a poly-hydroxy-alkanoate (PHA), or combinations thereof;
heating and mixing said fragments of said plant material and said polymeric material for obtaining a blend comprising said polymeric material in softened state with said fragments of said plant material dispersed in said polymeric material;
cooling said blend into solid state and grinding said cooled blend for obtaining said plurality of particles, wherein each of said particles comprises a polymeric matrix made of said polymeric material, and a reinforcing filler dispersed in said polymeric matrix, wherein said reinforcing filler is made of said plant material.

The expression “grinding a blend” comprises any possible action (e.g., crushing, milling, pulverizing, powdering, shredding, crumbling, smashing, scraping, etc.) suitable for reducing the starting size of the blend for obtaining the small size particles.

According to the Applicant, the use of a polymeric material selected in the above list is safe and/or healthy because it minimizes, or totally avoids, the health risks for the users of the synthetic turf surface and/or the pollution risks for the environment. In fact, the Applicant has experimentally observed (through a large test campaign) that, during biodegradation, the above polymeric materials produce (only) carbon dioxide, nitrogen, water and/or inorganic salts which are not toxic both for the users of the synthetic turf surface and the environment wherein the synthetic turf surface is positioned. Moreover, the above listed polymeric materials, when blended as herein described, have a biodegradation kinetic which is suitable for use in an infill material under the atmospheric conditions typically present in an environment wherein the synthetic turf surface is positioned (e.g., temperature ranging between 0-65° C., UR ranging between 30-90%, atmospheric pressure). For example, the (complete) biodegradation of the above polymeric materials may occur in a time interval ranging between 2-10 years. These biodegradation times render the use of the above listed polymeric materials for making the polymeric matrix of the infill material industrially and environmentally sustainable.

In addition, the use of a plant material as reinforcing filler (of no harm as well for both the users and the environment) allows obtaining a completely biodegradable and/or eco-friendly infill material, in combination with the use of the above listed polymeric materials for making the polymeric matrix. According to the Applicant, the infill material according to the present invention is also recyclable in case the synthetic turf surface has to be dismantled, thus favouring a circular economy and a saving of costs. It is also noted that the production cost of the infill material of the present invention is low since, on one hand, the cost of part of the raw material, e.g., the plant material, is very low, or substantially null; and, on the other hand, the re-use of materials is strongly incentivized given the high general attention to circular economy.

The Applicant has also experimentally observed that the infill material according to the present invention has suitable performance properties, e.g., in terms of mechanical behaviour (e.g., shock absorption, bouncing of the ball, etc.) and/or water-retaining properties.

The present invention in one or more of the aforesaid aspects can have one or more of the following preferred features.

Preferably said particles are fibres (as opposed to granules which have a generally circular shape).

Preferably the fibres have a dimension (“length”) much greater (e.g., at least ten times, preferably at least twenty times, greater) than at least one of (preferably both) the other two dimensions (width and thickness).

Preferably the fibres have a highly irregular shape (e.g., the surface of the fibre is jagged, possibly with thin, wry, filaments protruding from the surface).

The Applicant, without restricting to any theory, has observed that the fibrous, irregular, shape of the infill material, as compared to infill material made of generally round particles, enhances the performance properties of the infill material. For example, such fibrous, irregular, shape causes an intertwining of the fibres to form a “tangle” (where each fibre is, at least partially, mechanically bonded to the adjacent fibres), which provides a good stability of the infill material on the synthetic turf surface, since it allows limiting the migration of the single fibres in the side areas of the synthetic turf surface for example due to the running of the athletes and/or to the rebound of the ball and/or to atmospheric precipitation (e.g., flood). The Applicant has also observed that the “tangle” of fibres has a sponge-like structure provided by the void spaces between adjacent fibres of the “tangle”, which, according to the Applicant, provides for a triple beneficial effect. Firstly, the sponge-like structure allows a good mechanical behaviour (e.g., cushioning/shock absorption of the stresses due to the trampling action of the users playing on the surface and/or rebound of the ball and/or displacement of the particles during the rolling/bouncing of the ball and/or the trampling action of the users, in the jargon called “splash effect”) which results in an improved comfort for the users and/or in a reduction of injury risks and/or improved surface feed-back. Secondly, the sponge-like structure allows maintaining over time the dimensional properties of the infill material, even in face of the stresses underwent by the infill material during use. The Applicant has for example noted during testing that the fibrous sponge-like structure has a mechanical memory that acts quickly, reducing immediate compaction and the associated loss of performance, for example in a series of impact tests. The dimensional stability results in a lower wear of the infill material itself (for example due to rubbing between the fibres) and/or of the synthetic turf surface (e.g., a substantially fixed portion of the artificial fibres is left free and subjected to wear). Moreover, according to the Applicant, the dimensional stability is further enhanced by the use of plant material for making the reinforcing filler. In fact, the Applicant has experimentally observed that the fragments of plant material, during the heating and mixing operations, do not typically undergo a complete melting, or even remain substantially intact. According to the Applicant (without restricting to any theory), the plant material favours the maintaining over time of the dimensional properties of the fibres due to its effect of supporting structure. Thirdly, the sponge-like structure allows entrapping drops of water (e.g., rain, and/or actively sprayed on the surface) in the void spaces between the fibres, thus providing the desired water-retaining properties to the infill material. In this way, the overheating of the synthetic turf surface is limited (or completely avoided), with consequent reduction of damages of the surface and/or increase of the ergonomics of the surface for the users. The Applicant also believes that the high dimensional stability of the infill material (as explained above) allows maintaining the water-retaining properties substantially unchanged over time, since, during use of the surface, there is a low, or substantially null, permanent collapse of the infill (which at least partially tends to return to its original thickness) avoiding the occlusion (at least of part) of the void spaces between the fibres. Finally, the Applicant has also observed that the fibrous shape of the infill material allows to substantially replicate the feeling/perception that a user would have during trampling/playing on a natural grass surface, thus providing for a higher comfort for the users during use of the synthetic turf surface.

Preferably an average length (i.e., the main dimension) of the fibres (from a statistical point of view) is greater than or equal to 1 mm, more preferably greater than or equal to 1.5 mm, and/or less than or equal to 4 mm, more preferably less than or equal to 3 mm. Preferably an average thickness of the fibres (from a statistical point of view) is greater than or equal to 5 μm, more preferably greater than or equal to 10 μm, and/or less than or equal to 60 μm, more preferably less than or equal to 50 μm.

Preferably said plant material is selected in the group: olive pits, pine cones, wood sawdust, coconut fibre/peat, cork, rice husk, banana fibre/peat, lignin, tree defibration, hemp, corn pits, or combinations thereof. In this way, the cost of the infill material is limited (since they are typically scrap materials) and, furthermore, easily disposable materials are used, thus reducing the risk of pollution for the environment.

In one particularly preferred embodiment said plant material is olive pits, preferably dried in advance to said heating and mixing (for limiting vapour generation during blending). The Applicant believes that the large availability of this material helps reducing the costs of the infill material. Moreover, the hardness of the material further improves the abovesaid dimensional stability of the infill material.

Preferably said blend (or said particles) comprises a weight percentage of said plant material greater than or equal to 5%, more preferably greater than or equal to 10% mm, and/or less than or equal to 50%, more preferably less than or equal to 40%, of an overall weight of said blend (or particles).

Preferably providing said fragments of said plant material comprises grinding said plant material, preferably for obtaining (a substantial part of) said fragments with size less than 1 mm.

Preferably said polymeric material is selected in the group: polylactic acid (PLA), polybutylene adipate terephthalate (PBAT), polyglycolic acid (PGA), polycaprolactone (PCL), poly(lactic-co-glycolic) acid (PLGA), or combinations thereof. The Applicant has realized that the biodegradation kinetic of these materials is particularly suitable for use in an infill material. Moreover, these polymeric materials can be easily processed with many industrial techniques (e.g., extrusion) thus simplifying the overall production process of the infill material.

In one particularly preferred embodiment said polymeric material is polylactic acid (PLA). The Applicant has observed that particles comprising a polymeric matrix made of PLA and a reinforcing filler made of plant material are particularly suitable for use as infill material, since the biodegradation kinetic of the resulting composite material may be higher (i.e., the biodegradation is faster) than the biodegradation kinetic of PLA as such (which typically only occurs in certain conditions, e.g., temperature above 60° C.). The Applicant, without restricting to any theory, believes that the residual moisture content in the reinforcing filler made of plant material favours a partial hydrolysis of the PLA chains, thus making the resulting particles suitable for use as infill material.

In one alternative embodiment said polymeric material is a poly-hydroxy-alkanoate (PHA), more preferably is poly-hydroxy-butyrate (PHB).

Preferably said blend (or said particles) comprises a weight percentage of said polymeric material greater than or equal to 40%, more preferably greater than or equal to 50%, even more preferably greater than or equal to 60% mm, and/or less than or equal to 95%, more preferably less than or equal to 90%, of an overall weight of said blend (or particles). Preferably said particles comprise a plasticizing agent. Preferably the process comprises providing a plasticizing agent and heating and mixing said plasticizing agent with said fragments of said plant material and said polymeric material. Preferably said plasticizing agent is an epoxidized vegetable oil, more preferably selected in the group of epoxidized Vernonia oil, epoxidized linseed oil and epoxidized soybean oil (ESBO). In one particularly preferred embodiment said plasticizing agent is epoxidized soybean oil (ESBO).

Preferably said blend (or said particles) comprises a weight percentage of said plasticizing agent greater than or equal to 1.5%, more preferably greater than or equal to 2% mm, and/or less than or equal to 12%, more preferably less than or equal to 10%, of an overall weight of said blend (or said particles).

The Applicant believes that the addition of a plasticizing agent enhances the workability of the polymeric material and/or the embedding of the reinforcing filler in the polymeric matrix, since the plasticizing agent makes the polymeric material softer (e.g., decrease its viscosity) and more flexible (e.g., increase its plasticity). Moreover, the Applicant has observed that the above plasticizing agents have a biodegradation kinetic suitable for use in an infill material. Finally, the Applicant has observed that the above plasticizing agents facilitate obtaining the infill material in fibrous form by grinding the blend, with the abovesaid advantages in terms of performance properties.

Preferably said particles comprise a biocidal agent. Preferably the process comprises providing a biocidal agent and heating and mixing said biocidal agent with said fragments of said plant material and said polymeric material.

Preferably said blend (or said particles) comprises a weight percentage of said biocidal agent greater than or equal to 0.1%, more preferably greater than or equal to 0.2%, and/or less than or equal to 5%, more preferably less than or equal to 3%, of an overall weight of said blend (or said particles).

Preferably said biocidal agent is selected in the group: organic silanes, chlore-based biocidal agents, zinc-based biocidal agents (e.g., zinc pyrithione), or combinations thereof. More preferably said biocidal agent is an organic silane. The Applicant has found that these components allow for a high protection against microorganisms that could possibly proliferate on the synthetic turf surface.

Preferably said organic silanes are selected in the group: dimethyl-dichloro-silanes; trimethylsilyl-chlorides; trimethoxysilyl-chlorides; methyl-trichloro-silanes; or combinations thereof. In this way, it is used an easily available biocidal agent having good biocidal, in particular antibacterial, properties.

In one particularly preferred embodiment said biocidal agent is a trimethoxysilyl-chloride. In this way, according to the Applicant, a class of compounds able to provide high biocidal properties to the infill material is used, since the compounds of the above class maintain over time the bacterial load at very low, if not null, levels.

Preferably said chlore-based biocidal agent is a chlorophenoxy-phenol. More preferably said biocidal agent is 5-chloro2-(4-chlorophenoxy)-phenol. In this way, the biocidal agent is provided with a broad-spectrum biocidal action since chlorophenoxy-phenols are also effective against molds and fungi.

Preferably said particles comprise one or more additives. Preferably the process comprises providing one or more additives and heating and mixing said one or more additives with said fragments of said plant material and said polymeric material.

Preferably said one or more additives are selected among anti-oxidants (e.g., having a thermo-stabilizing function), anti-UV rays and/or dyes. In this way it is possible simply providing particular properties to the infill material.

Preferably said blend (or said particles) comprises a weight percentage of each of said one or more additives greater than or equal to 0.1% and/or less than or equal to 5% of an overall weight of said blend (or said particles).

Preferably said heating and mixing is performed in an extruder. In this way, the heating and mixing of (at least) the fragments of plant material and the polymeric material is carried out efficiently.

Preferably said extruder is a twin-screw extruder, preferably with co-rotating screws at least partially penetrating. Preferably the extruder is structured so that the rotation velocity of the screws is greater than or equal to 100 rpm, more preferably greater than or equal to 150 rpm, even more preferably greater than or equal to 200 rpm, and/or less than or equal to 700 rpm, more preferably less than or equal to 600 rpm, even more preferably less than or equal to 500 rpm. Preferably, during said heating and mixing, a pressure in said extruder is greater than or equal to 15 bar, more preferably greater than or equal to 20 bar, and/or less than or equal to 45 bar, more preferably less than or equal to 40 bar. In this way a suitable machine which can operate in suitable working conditions for obtaining the infill material is provided.

Preferably said heating comprises bringing (at least) said fragments of said plant material and said polymeric material to a temperature greater than or equal to 160° C., more preferably greater than or equal to 170° C., and/or less than or equal to 250° C., more preferably less than or equal to 220° C. This temperature allows the homogeneous softening of the above polymeric materials.

Preferably said heating comprises bringing (at least) said fragments of said plant material and said polymeric material to a temperature greater than or equal to a melting temperature of said polymeric material and less than or equal to a scorching temperature of said plant material. In this way, it is possible avoiding a total burnout of the plant material which make up the reinforcing filler of the particles.

Preferably, before said cooling said blend, it is provided extruding said blend for obtaining a continuous stripe of blend. Preferably said cooling said blend comprises cooling (preferably by means of water baths and subsequent drying, e.g., by means of air) said continuous stripe of blend, preferably to room temperature (i.e., 20-25° C.).

Preferably before grinding said cooled blend the process comprises obtaining pellets of blend (e.g., small cylinders or eggs), more preferably pelletizing said continuous stripe. Preferably said pellets of blend are in the form of sticks. Preferably said pellets have a length greater than or equal to 3 mm, more preferably greater than or equal to 4 mm, and/or less than or equal to 15 mm, more preferably less than or equal to 12 mm, and/or have a thickness (e.g., a diameter) greater than or equal to 2 mm, more preferably greater than or equal to 3 mm, and/or less than or equal to 7 mm, more preferably less than or equal to 5 mm.

Preferably grinding said cooled blend comprises grinding said pellets of blend and sieving said grinded pellets of blend for obtaining said particles. Preferably said sieving said grinded pellets of blend is performed by a sieve having hole size greater than or equal to 0.2 mm, more preferably greater than or equal to 0.4 mm, and/or less than or equal to 6 mm, more preferably less than or equal to 4 mm.

Preferably said particles of the infill material have a real density greater than or equal to 1 g/cm³, more preferably greater than or equal to 1.10 g/cm³, even more preferably greater than or equal to 1.20 g/cm³ (and preferably less than or equal to 1.30 g/cm³). The Applicant has experimentally observed that the above density of the infill material helps to maintain the position of the particles on the synthetic turf surface, thus limiting (or avoiding) the accumulation of the infill material in the side areas of the synthetic turf surface.

In one embodiment the infill material is a mixture comprising said particles and further infill particles. Preferably the process comprises (heterogeneously) mixing the particles according to any embodiments of the present invention with further infill particles. Preferably said further infill particles are (entirely) made of sand or pea gravel, or plant material, more preferably said further infill particles are (dried) olive pits, more preferably having size between 0.5 mm-2.5 mm. Preferably a weight content in said mixture of said particles is greater than or equal to 5% and/or less than or equal to 50%, more preferably less than or equal to 40%, even more preferably less than or equal to 30%.

According to a further aspect the invention relates to a synthetic turf surface comprising a synthetic turf mat and a layer of an infill material (produced) according to any embodiment of the present invention, the layer being arranged above said synthetic turf mat. In this way, the desired biodegradability and/or the desired performance properties (e.g., in terms of wear resistance and/or low abrasion risk for the users and/or adherence for the users) and/or the desired aesthetic properties (e.g., likelihood to the natural grass) are provided to the synthetic turf surface.

Preferably said infill material of said layer has a sponge-like structure.

Preferably said infill material has an apparent density (according to EN 1097-3) less than or equal to 0.8 g/cm³, more preferably less than or equal to 0.6 g/cm³, even more preferably less than or equal to 0.4 g/cm³ (and preferably greater than or equal to 0.05 g/cm³). The Applicant has experimentally observed that the above apparent density of the infill material, obtained by a sufficient proportion of voids between the fibers, provides excellent performances described above.

Preferably said layer of infill material has a mass per unit area greater than or equal to 2 kg/m², more preferably greater than or equal to 5 kg/m², and/or less than or equal to 15 kg/m², more preferably lower or equal to 12 kg/m². In this way, the appropriate amount of infill material is provided for giving the desired properties to the synthetic turf surface.

### BRIEF DESCRIPTION OF THE DRAWINGS

FIG. 1 schematically shows in vertical section a synthetic turf surface comprising a layer of infill material according to the present invention;

FIG. 2 shows a block diagram of a production process of an infill material according to the present invention;

FIG. 3 shows a picture of an infill material according to the present invention.

### DETAILED DESCRIPTION OF SOME EMBODIMENTS OF THE INVENTION

The features and the advantages of the present invention will be further clarified by the following detailed description of some embodiments, presented by way of non-limiting example of the present invention, with reference to the attached figures.

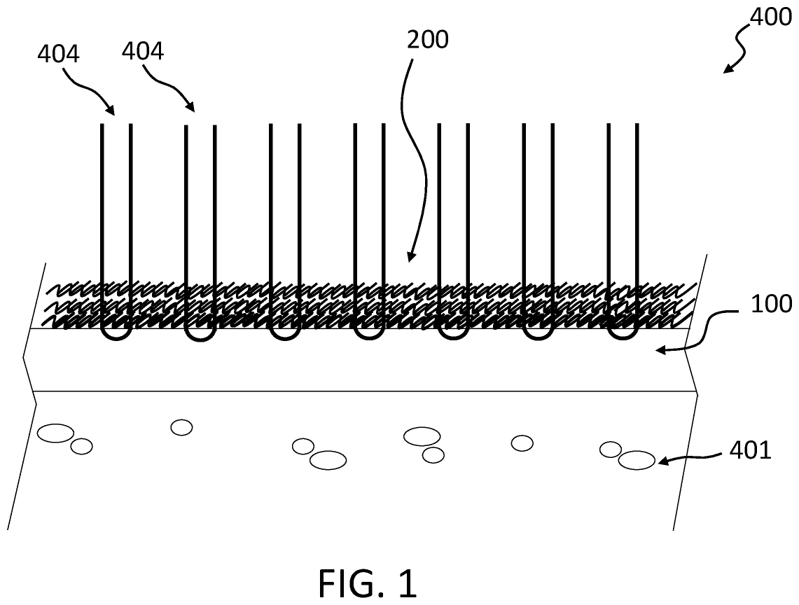

With reference to FIG. 1, it is schematically shown a synthetic turf surface 400 comprising a compact clay substrate 401 (for example as known) and a synthetic turf mat 100 (e.g., of known type and not further described) laid on the substrate 401. Typically, the synthetic turf mat 100 comprises a plurality of artificial fibres 404 (which simulate the grass threads) for example woven by tufting in the synthetic turf mat 100. The synthetic turf surface 400 further comprises one layer of infill material 200 arranged on the synthetic turf mat 100 between the artificial fibres 404. Exemplarily the layer of infill material 200 has a thickness equal to about 10 mm and a mass per unit area exemplarily equal to about 6.3 kg/m².

Typically, the infill material of the present invention constitutes a performance infill of the synthetic turf surface 400 and therefore it is arranged at the top of the infill. Typically, under the layer of infill material 200, a layer of stabilizing material (not shown), exemplarily made of sand or pea gravel, is provided.

The infill material 200 comprises a plurality of particles 201 according to the present invention.

In one embodiment, the infill material 200 consists solely of said particles 201. Alternatively, and preferably, the infill material 200 is a mixture of the particles 201 with further infill particles such as granules made of a plant material. Exemplarily said further infill particles are dried olive pits, the mixture comprising exemplarily 10% by weight of said particles 201 and 90% by weight of said olive pit particles.

According to the invention, each of the particles 201 comprises a polymeric matrix exemplarily made of polylactic acid (PLA) and a reinforcing filler dispersed in the polymeric matrix, wherein the reinforcing filler is exemplarily made of olive pits.

Exemplarily the infill material 200 has real density equal to about 1.26 g/cm³, measured according to standard ISO 1183-1/A, and an apparent density equal to about 0.1-0.2 g/cm³ measured according to standard EN 1097-3.

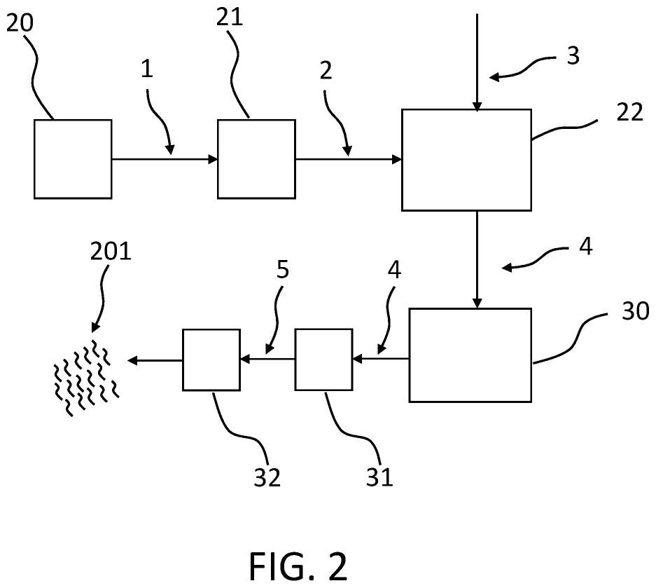

With reference to FIG. 2, reference number 20 schematically indicates a container for collecting the olive pits 1, e.g., full olive pits coming from the food and/or agricultural industry. After collection, the process exemplarily comprises grinding the olive pits 1 to obtain fragments 2 of olive pits. The grinding is exemplarily carried out by feeding the olive pits 1 to one or more grinding mills 21 (only schematically shown) in which for example there is a respective blades/counter-blades system (for example of known type). For example, the grinding can comprise a coarse pre-grinding of the olive pits 1 and a subsequent fine grinding. In this way about 85-90% in weight of the fragments has spatial dimension less than or equal to 1 mm (this favours the incorporation of the fragments in the polymeric matrix as explained below).

The process comprises feeding the fragments 2 and an amount 3 of polylactic acid (PLA) to an extruder 22. Exemplarily before the feeding (possibly before the above grinding), the fragments 2 are dried, e.g., in a convection oven (not shown) thermostated at an exemplary temperature of 50° C. for a time interval of about 12 hours, and also the PLA is dried, e.g., in a dehumidifier at an exemplary temperature of 100° C. for a time interval of about 12 hours (in this way it is possible to keep low the moisture evaporation within the inner chamber of the extruder).

Exemplarily, the extruder 22 is a twin-screw extruder with co-rotating screws at least partially penetrating. Exemplarily the working condition of the twin-screw extruder are: rotation velocity of the screws equal to about 300 rpm and pressure equal to about 30 bar.

Exemplarily, together with the fragments 2 and the polylactic acid, a plasticizing agent is fed to the extruder 22. Exemplarily the plasticizing agent is epoxidized soybean oil (ESBO), having CAS number: 8013-07-8.

Exemplarily, together with the fragments 2 and the polylactic acid, an anti-oxidant additive (e.g., having thermo-stabilizing function), an anti-UV-rays additive, and a dye are fed to the extruder 22.

Exemplarily, together with the fragments 2 and the polylactic acid, a biocidal agent is fed to the extruder 22. Exemplarily the biocidal agent is a trimethoxysilyl-chloride, for example having CAS number: 19911-50-70, or it is 5-chloro2-(4-chlorophenoxy)-phenol, having CAS number: 3380-30-1.

Possibly, together with the fragments 2 and the polylactic acid, also a further reinforcing material can be fed to the extruder 22. For example, the further reinforcing material is a mineral material selected in the group: calcium carbonate, talc, sand, lime, or combinations thereof. This allow reducing the overall production costs of the infill material, given the great availability of the above mineral materials.

For example, the extruder 22 comprises a plurality of feeding mouths distributed along the main development direction of the extruder 22. In this way it is possible feeding the above components either to the same feeding mouth or to feeding mouths spatially separated from each other. In this way, the components can be mixed and/or heated at a different extent (e.g., different time intervals) depending on the position of the feeding mouth used for their introduction in the extruder 22.

Alternatively, or in combination, the process can provide preparing a mixture of one or more of the above components inside a further mixing device (for example of known type), the latter acting as a tank for feeding the mixture to the extruder. For example, the further mixing device comprises a stirring and feeding device which carries out a forced mixing of the components for obtaining the mixture and the feeding of a predetermined amount of mixture to the extruder.

Following the feeding of the components to the extruder 22, the process comprises heating, exemplarily to a temperature equal to about 190° C., and mixing the components inside the extruder 22 for obtaining a (heterogeneous) blend comprising the PLA in a softened state and all the other components (including the fragments 2 of olive pits) dispersed and/or distributed in the PLA.

Exemplarily the extruder 22 comprises a series of heating elements (of known type, not shown) for allowing the heating. The mixing of the blend, as well as its displacement along the extruder, is carried out by the rotation of the screws of the extruder 22 (which are at least partially helicoidal screws).

Exemplarily the components fed into the extruder 22 enters, by rotation of the screws, in a compression area wherein the blend is formed, with the PLA that softens when subjected to strong pressures and heat application.

Exemplarily the final blend comprises the following composition: 57% of PLA, 30% of fragments of olive pit, 7% of ESBO, 1% of anti UV-rays additive, 1% of anti-oxidant additive, 3% of dye and 1% of biocidal agent.

Finally, the blend is moved towards the extrusion/outlet head of the extruder 22 for being extruded.

Exemplarily the blend is extruded in the form of a continuous stripe 4. This continuous stripe 4 is transported, exemplarily by a pulley system and/or a roller system (not shown), to a cooling station 30 for being cooled. Exemplarily the cooling station 30 comprises one or more containers (e.g., in series) with water at room temperature, with the continuous stripe 4 that is immersed in the water. After the cooling operation, the continuous stripe 4 is transported to a drying station (not shown), exemplarily comprising an air blower, for being dried.

Once the continuous stripe 4 has been dried, the continuous stripe 4 is pelletized (for example by a suitable pelletizer 31 of known type) to obtain pellets 5 of blend. Exemplarily the pellets 5 of blend are in the form of sticks having a length exemplarily equal to about 8 mm and a diameter exemplarily equal to about 5 mm.

The pellets 5 of blend are then exemplarily continuously fed to a grinding mill 32 which carries out a grinding of the pellets 5 of blend for obtaining the particles 201.

Exemplarily, the grinding mill 32 comprises a sieving device (not shown) which cooperates with the grinder and avoids that the particles 201 are ejected before the desired size is obtained.

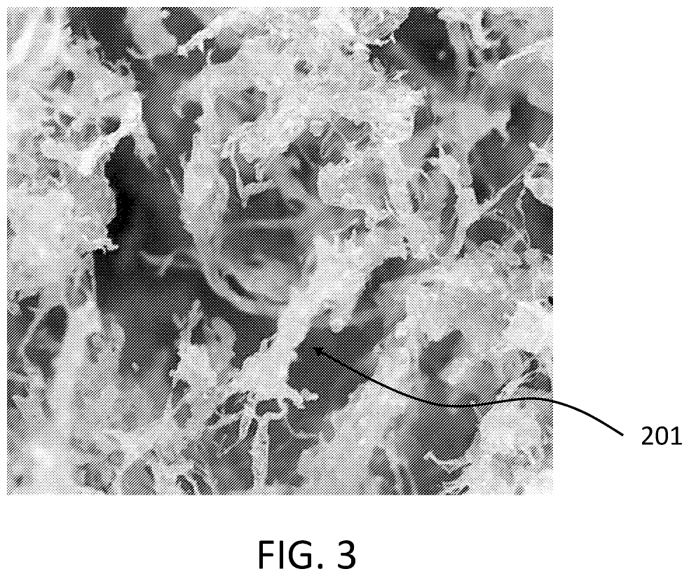

Exemplarily the particles 201 are in the form of fibres, as shown in FIG. 3 which represents a photograph of the fibres 201 taken at the microscope. Exemplarily the fibres have a main dimension, which is exemplarily called “length”, greater than both its width and thickness. Exemplarily an average length of the fibres 201 is equal to about 3 mm and an average thickness of the fibres 201 is exemplarily equal to about 50 μm. These average dimensions of the fibres have been exemplarily taken by microscope measurement with a statistical approach. For example, it is possible to take a sample of fibers (in predetermined number) and to evaluate the number of fibres needed for occupying the so called “field of view” of the microscope which has a standard dimension. The average dimension of the fibers is exemplarily obtained by the ratio between the length of the “field of view” of the microscope and the number of fibres needed for entirely occupying the “field of view”.

Exemplarily the fibres 201 have a highly irregular shape, for example having a jagged profile along the main dimension (the length) with thin, wry, filaments protruding from the surface of the fibres (as shown in FIG. 3). This helps the entanglement of the fibres and the formation of a sponge-like structure, as explained above.

1. Infill material for a synthetic turf surface, said infill material comprising a plurality of particles, each one comprising:
a polymeric matrix made of a polymeric material selected in the group: polylactic acid (PLA), polybutylene adipate terephthalate (PBAT), polyglycolic acid (PGA), polycaprolactone (PCL), poly(lactic-co-glycolic) acid (PLGA), poly-(2-hydroxyethyl-methacrylate), poly-ethylene-glycol (PEG), chitosan, hyaluronic acid, a poly-hydroxy-alkanoate (PHA), or combinations thereof;
a reinforcing filler dispersed in said polymeric matrix, the reinforcing filler being made of a plant material.

2. Infill material according to claim 1, wherein the particles have a real density greater than or equal to 1 g/cm³, wherein said particles are fibres having highly irregular shape and a dimension at least ten times greater than at least one of the other two dimensions, wherein an average length of the fibres is greater than or equal to 1 mm and less than or equal to 4 mm, and wherein an average thickness of the fibres is greater than or equal to 5 μm and less than or equal to 60 μm.

3. Infill material according to claim 1, wherein said plant material is selected in the group: olive pits, pine cones, wood sawdust, coconut fibre/peat, cork, rice husk, banana fibre/peat, lignin, tree defibration, hemp, corn pits, or combinations thereof, and wherein said particles comprise a weight percentage of said plant material greater than or equal to 5% and less than or equal to 50% of an overall weight of said particles.

4. Infill material according to claim 1, wherein said polymeric material is selected in the group: polylactic acid (PLA), polybutylene adipate terephthalate (PBAT), polyglycolic acid (PGA), polycaprolactone (PCL), poly(lactic-co-glycolic) acid (PLGA), or combinations thereof, and wherein said particles comprise a weight percentage of said polymeric material greater than or equal to 50% and less than or equal to 95% of an overall weight of said particles.

5. Infill material according to claim 1, wherein said particles comprise a plasticizing agent, wherein said plasticizing agent is an epoxidized vegetable oil selected in the group of epoxidized Vernonia oil, epoxidized linseed oil and epoxidized soybean oil (ESBO), wherein said particles comprise one or more additives selected among anti-oxidants, anti-UV rays and/or dyes, and wherein said particles comprise a biocidal agent selected in the group: organic silanes, chlore-based biocidal agents, zinc-based biocidal agents, or combinations thereof.

6. Infill material according to claim 1, wherein said plant material is olive pits, wherein said polymeric material is polylactic acid (PLA), wherein said particles comprises a plasticizing agent which is epoxidized soybean oil (ESBO), and wherein said particles comprises a biocidal agent which is a trimethoxysilyl-chloride or 5-chloro2-(4-chlorophenoxy)-phenol.

7. Infill material according to claim 1, wherein the infill material is a mixture comprising said particles and further infill particles, wherein said further infill particles are made of plant material, preferably said further infill particles are dried olive pits having size between 0.5 mm-2.5 mm, and wherein a weight content in said mixture of said particles is greater than or equal to 5% and less than or equal to 50%.

8. Production process of an infill material for a synthetic turf surface, wherein the infill material comprises a plurality of particles, the process comprising:
providing fragments of a plant material;
providing a polymeric material selected in the group: polylactic acid (PLA), polybutylene adipate terephthalate (PBAT), polyglycolic acid (PGA), polycaprolactone (PCL), poly(lactic-co-glycolic) acid (PLGA), poly-(2-hydroxyethyl-methacrylate), poly-ethylene-glycol (PEG), chitosan, hyaluronic acid, a poly-hydroxy-alkanoate (PHA), or combinations thereof;
heating and mixing said fragments of said plant material and said polymeric material for obtaining a blend comprising said polymeric material in softened state with said fragments of said plant material dispersed in said polymeric material; and
cooling said blend into solid state and grinding said cooled blend for obtaining said plurality of particles, wherein each of said particles comprises a polymeric matrix made of said polymeric material, and a reinforcing filler dispersed in said polymeric matrix, wherein said reinforcing filler is made of said plant material.

9. Production process according to claim 8, wherein providing said fragments of said plant material comprises grinding said plant material for obtaining said fragments with size less than 1 mm, wherein said blend comprises a weight percentage of said plant material greater than or equal to 5% and less than or equal to 50% of an overall weight of said blend, and wherein said blend comprises a weight percentage of said polymeric material greater than or equal to 40% and less than or equal to 95% of an overall weight of said blend.

10. Production process according to claim 8, comprising:
providing a plasticizing agent, providing one or more additives, providing a biocidal agent; and
heating and mixing said plasticizing agent, said one or more additives, and said biocidal agent with said fragments of said plant material and said polymeric material.

11. Production process according to claim 10, wherein said blend comprises:
a weight percentage of said plasticizing agent greater than or equal to 1.5% and less than or equal to 12% of an overall weight of said blend;
a weight percentage of each of said one or more additives greater than or equal to 0.1% and less than or equal to 5% of an overall weight of said blend; and
a weight percentage of said biocidal agent greater than or equal to 0.1% and less than or equal to 5% of an overall weight of said blend.

12. Production process according to claim 8, wherein said heating and mixing is performed in an extruder (22) which is a twin-screw extruder, wherein said extruder is structured so that the rotation velocity of the screws is greater than or equal to 100 rpm and less than or equal to 700 rpm, and wherein, during said heating and mixing, a pressure in said extruder is greater than or equal to 15 bar and less than or equal to 45 bar.

13. Production process according to claim 8, wherein said heating comprises:
bringing said fragments (2) of said plant material and said polymeric material to a temperature greater than or equal to 160° C. and less than or equal to 250° C.; and
bringing said fragments (2) of said plant material and said polymeric material to a temperature greater than or equal to a melting temperature of said polymeric material and less than or equal to a scorching temperature of said plant material.

14. Production process according to claim 8, comprising:
before said cooling said blend, extruding said blend for obtaining a continuous stripe of blend, wherein said cooling said blend comprises cooling said continuous stripe of blend to room temperature; and
before grinding said cooled blend, obtaining pellets of blend by pelletizing said continuous stripe,
wherein grinding said cooled blend comprises grinding said pellets of blend and sieving said grinded pellets of blend for obtaining said particles.

15. Synthetic turf surface comprising a synthetic turf mat and a layer of an infill material according to claim 1, said layer being arranged above said synthetic turf mat, wherein said layer of infill material has a mass per unit area greater than or equal to 2 kg/m² and less than or equal to 15 kg/m².
